(19) United States
(12) Patent Application Publication
(10) Pub. No.: US 2016/0203730 A1
(43) Pub. Date: Jul. 14, 2016

(54) SYSTEM FOR PROMOTING A SECURE PARENT/CHILD ATTACHMENT BOND

(71) Applicant: Simms/Mann Institute for Education and Community Developement, Beverly Hills, CA (US)

(72) Inventor: Victoria M. Simms, Beverly Hills, CA (US)

(21) Appl. No.: 14/994,000

(22) Filed: Jan. 12, 2016

Related U.S. Application Data
(60) Provisional application No. 62/102,252, filed on Jan. 12, 2015.

(51) Int. Cl. G09B 19/00

(52) U.S. Cl. CPC G09B 19/00

(57) ABSTRACT

A system with a transitional object to promote the bond between children and adults by exchanging that object when in the absence or presence of the adult. Preferably the system is used between children and parents. The system has a three-dimensional object, an article that may be worn or otherwise easily carried by an adult, and an attachment on the three-dimensional object for storing the article. When the parent and child are together the article is placed on the three-dimensional object, and when the parent leaves the child, the article is removed and kept with the parent. Upon returning to the child the parent re-attaches the article to the three-dimensional object. This ritual and routine promotes bonding between an adult and child.

### CROSS REFERENCE TO RELATED APPLICATIONS/INCORPORATION BY REFERENCE STATEMENT

The present application incorporates by reference the entire provisional application identified by U.S. Ser. No. 62/102,252 filed on Jan. 12, 2015, and claims priority to that application under 35 U.S.C. §119(e).

### BACKGROUND

Changing economic conditions has greatly increased the number of households where all the parents work outside of the home. Combined with the increasing 24/7 work culture, parents have less time they can spend with their children. So, stable and caring relationships that provide consistency and predictability between parents and children are more important than ever.

Most parents want to do everything possible to support their child's healthy development but feel stretched for time and baffled about where to begin. Among other things, parents want to provide their toddlers with opportunities for reciprocal social interactions. These early interpersonal exchanges, which researchers are calling “serve and return” have enormous impact on their babies developing brain architecture. Neuroscience research now verifies that a child's early experiences set the stage for lifelong learning, behavior and health.

Distress at separation is a perfectly normal part of childhood and can start during infancy, toddlerhood or preschool. Initially, newborn children are totally dependent on their parents and see their parent(s) as an extension of them. Around four months old, children become more aware of their surroundings and begin to see their parent as a separate person. In fact, at this point children have difficulty understanding that their parents continue to exist when they cannot see them. Moreover because children generally don't have a concept of time, they don't know if or when their parents will come back. This is true even if the parent is just in another room. This disappearance can make the children feel alone and disconnected from their parent, creating uncertainty, fear or anxiety.

Children have always found comfort in the familiar, soft touch of a security blanket, lovie or cuddly toy. These types of objects are referred to by researchers as transitional objects. In fact, people of all ages use transitional objects, from students taking their stuffed animal to college to heirlooms with special meaning that link us to past generations.

There is a need for a system that provides the benefit of a transitional object with further benefits to promote the bond between adults and children.

### SUMMARY OF THE INVENTION

In one aspect of the invention, a system for promoting a secure parent/child attachment bond is disclosed. The system includes a three-dimensional object, an article that may be worn or otherwise easily carried by an adult, wherein the three-dimensional object includes means for temporarily attaching the removable attachment to the three-dimensional object.

In another aspect of the invention, a system for promoting a secure parent/child attachment bond is disclosed. The system includes a three-dimensional object, an article that may be worn or otherwise easily carried by an adult, wherein the three-dimensional object includes means for temporarily attaching the removable attachment to the three-dimensional object, and a plurality of cards, wherein each card carries text that provides rituals, routines, and/or tips to promote parent-child bonding.

In another aspect of the invention, a method for creating a secure parent/child attachment bond is disclosed. The method includes providing a child with a three-dimensional object, wherein the three-dimensional object has an attachment means and an article attached to the three-dimensional object by the attachment means; removing the article attached to the three-dimensional object by the attachment means when a parent separates from the child; attaching the article to the parent when the parent separates from the child; and re-attaching the article by the attachment means to the three-dimensional object at the time the parent returns to the child.

### BRIEF DESCRIPTION OF THE DRAWINGS

FIG. 1 is a front perspective view of an embodiment of the present invention.

FIG. 2 is a front perspective view of FIG. 1 without the three dimensional object.

FIG. 3 is a perspective of an embodiment of the removable attachment.

FIG. 4 is a side view of another embodiment of the present invention.

FIG. 5 is a side view of another embodiment of the present invention.

FIG. 6 is a front perspective view of another embodiment of the present invention.

FIG. 7 is a front perspective of an embodiment of the three dimensional object.

FIG. 8 is a demonstrative of a use of the three dimensional object and removable attachment between a child and a parent.

The foregoing figures potential illustrations of a three-dimensional object and removable attachment, using in particular the example of a lovie (with an animal head) and bracelet. It should be understood by those skilled in the art that these figures do not limit the associated disclosure but merely exemplify it.

### DETAILED DESCRIPTION OF THE INVENTION

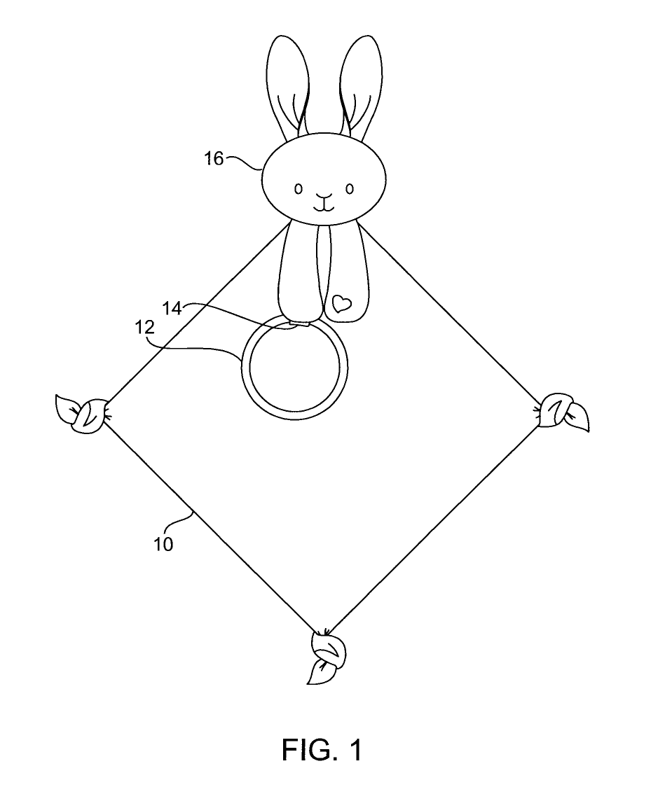

As shown in FIG. 1, generally, the invention is a system that comprises a three-dimensional object 10 that is also preferably capable of absorbing the scent of a human and a removable attachment 12 that may be worn or otherwise easily carried by an adult.

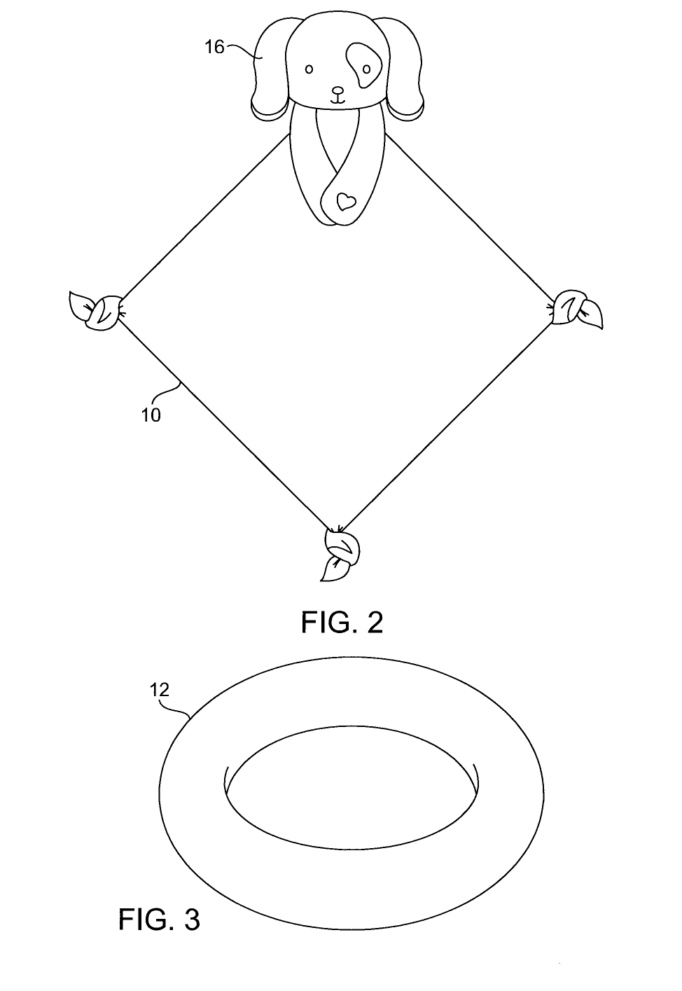

As shown in FIG. 2, the three-dimensional object 10 is preferably soft and may be, among other possibilities, a blanket, lovie, swaddle, plush or semi-plush toy. Alternatively, it is envisioned that the three-dimensional object may be semi-soft, such as a book, a rattle, a ball, or any other semi-soft baby-related item. It is also envisioned that a rigid three-dimensional object may also be utilized.

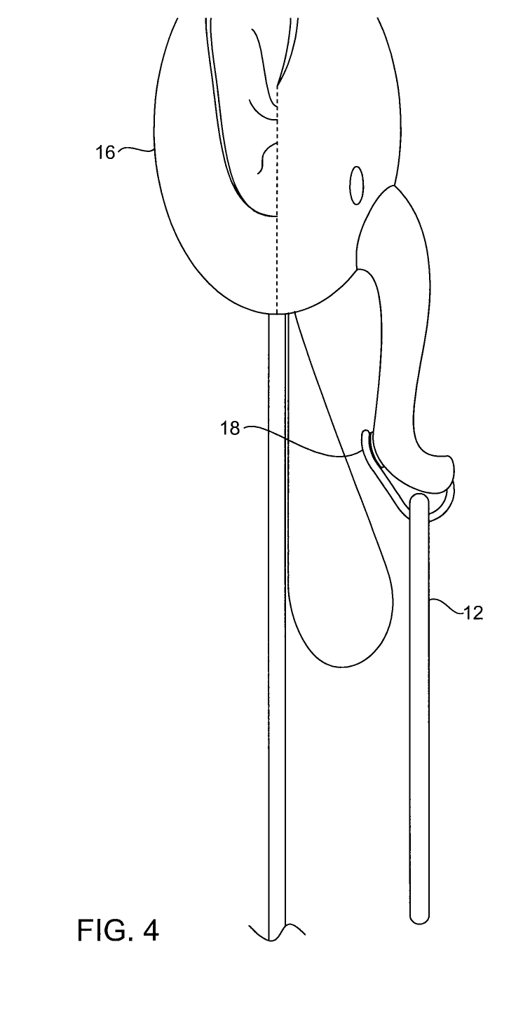

The removable attachment 12 may be, among other possibilities, a bracelet, pendent, ring, pin, or tie clip. In any event, the removable attachment 12 should be constructed from material that is safe for a child to place in their mouths, such as a 100% (BPA free) silicone. The removable attachment 12 can be configured in any shape as long as it is configured in a manner in which the child will not swallow the removable attachment 12 or otherwise injure themselves. Most preferably, the removable attachment 12 is a bracelet. As shown in FIG. 3, in instances where the removable attachment 12 is a bracelet, it is preferably round, but may be in alternative shapes, including, but not limited to square or hexagonal. The bracelet 12 also preferably has rounded edges, but may also have non-rounded edges.

As shown in FIGS. 1, and 4-6, in one embodiment the system the three-dimensional object 10 is a lovie with an animal head 16 and the removable attachment 12 is a bracelet. The animal head 16 may be any animal including, but not limited to a dog, a duck, a dinosaur, a monkey, a cat, a lion, a tiger, a penguin, a rabbit, and an elephant. It is contemplated that head 16 could be a licensed character (e.g. Mickey Mouse, Elmo, and Hello Kitty).

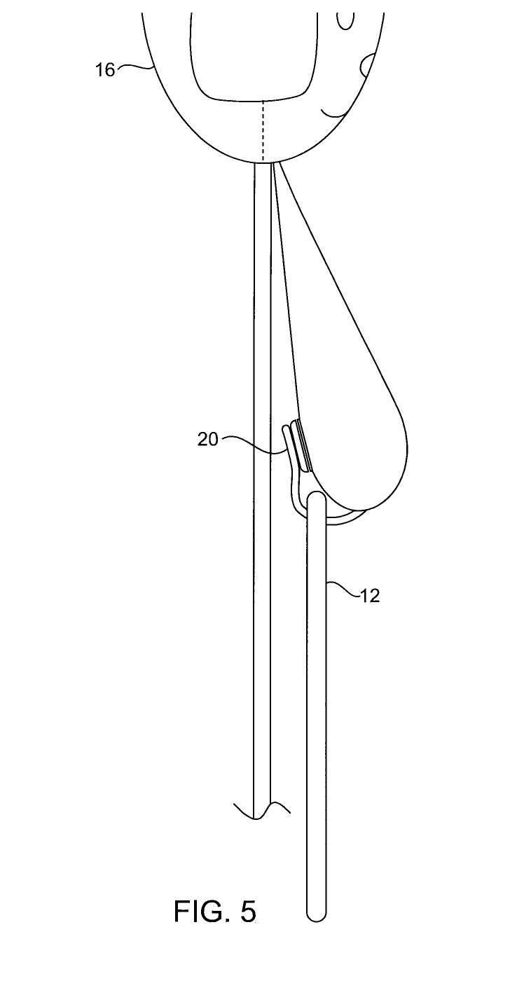

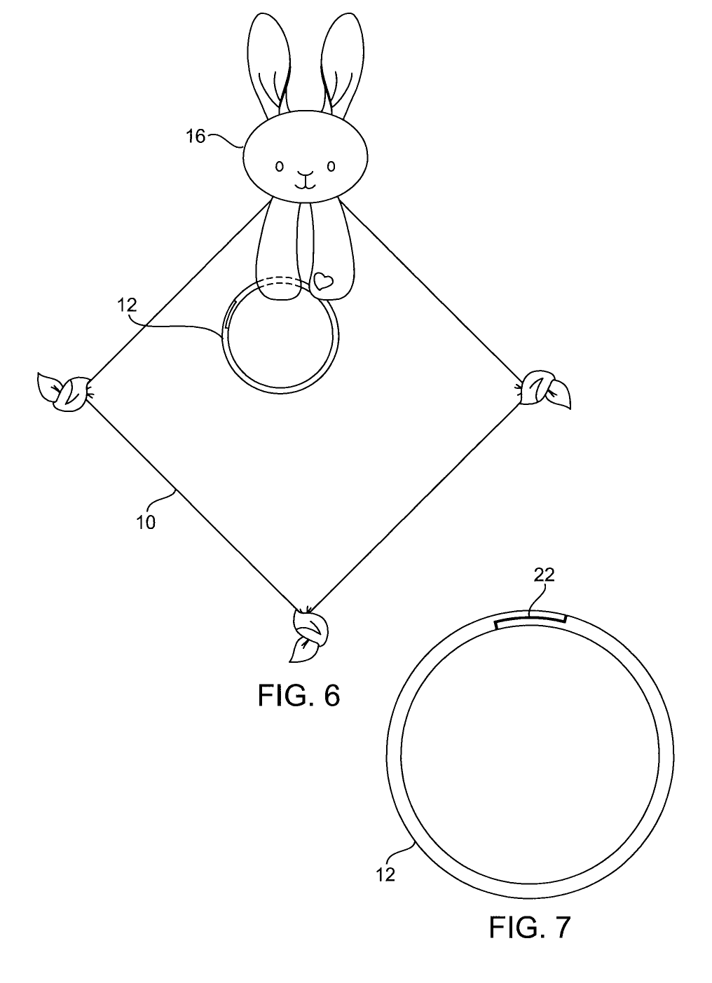

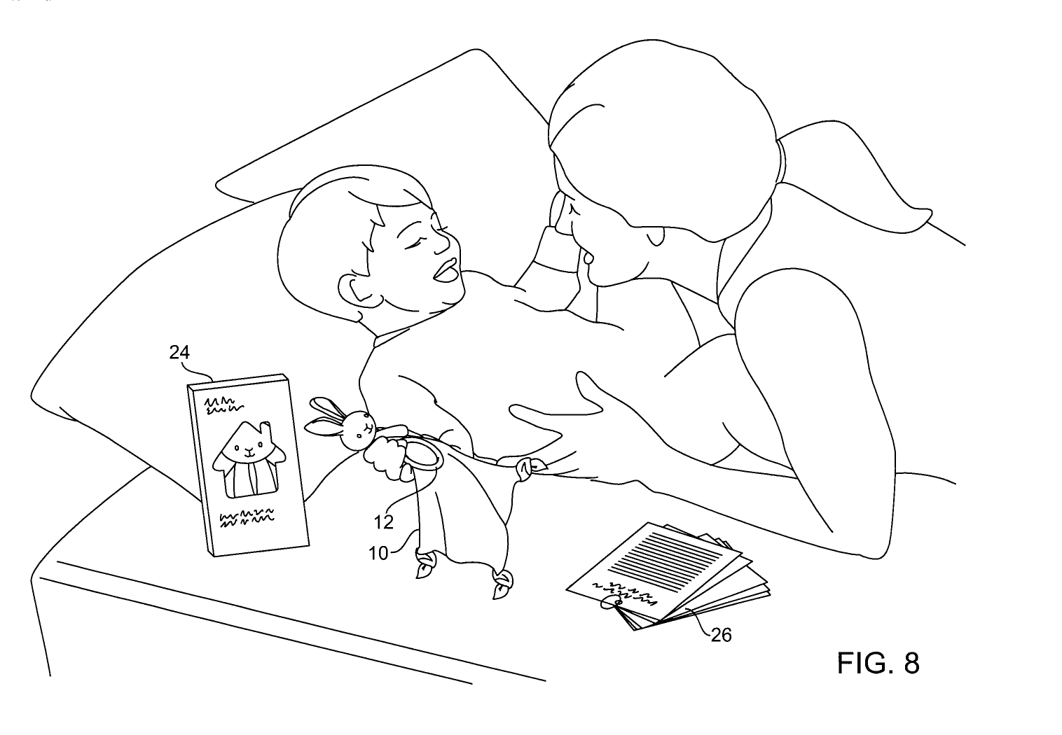

As shown in FIGS. 4-6, the three-dimensional object 10 may have means for temporarily attaching 14 the removable attachment 12. As shown in FIGS. 4-5, the removable attachment 12 may be accomplished by through different means. As shown in FIG. 4, of a loop of material (e.g. fabric) that is long enough to wrap around the removable attachment 12 and be temporarily closed by way of a hook and loop fastener pair 18 (such as a Velcro®-brand fastener). Alternatively, as shown in FIG. 5, the fastener may be a snap 20 (preferably plastic). Alternatively, the fastener may be a button-buttonhole combination, or it is envisioned that any fastener that is child appropriate may be used. Where the three-dimensional object 10 is formed of fabric, it would be possible for the removable attachment 12 to be removably attached by simply tying a knot in the three-dimensional object 10 around the removable attachment 12. Alternatively, as shown in FIGS. 6 and 7, the removable attachment 12 may be separable means 22 that will allow the removable attachment 12 to attach to the three-dimensional object 10.

The system may also include a second removable attachment 12, such that in two parent families, both parents may have a removable attachment 12. In such systems the means for temporarily attaching the removable attachment 12 may accommodate both articles.

As shown in FIG. 8, the system may also include cards 26 carrying text that provides rituals, routines, and/or tips to promote parent-child bonding. As shown in FIG. 8, the cards 26 are preferably bound together by some sort of binding means, such as a ring 28, or any other type of binding that will hold the cards together. The binding should preferably be made with child safe materials. Alternatively, the cards may be stored individually, or stored within a package. The cards 26 should be made of a sturdy material and of a thickness which makes them difficult to be destroyed (torn, ripped, chewed) if handled by a child. Preferably the cards 26 are made of cardboard, but other materials are also envisioned, including, but not limited to plastic and wood. Also, preferably the cards 26 are rectangular shaped, but other configurations are envisioned.

As shown in FIG. 8, the invention preferably also includes a package (or box) 24 to store the three-dimensional object 10, the removable attachment 12, and the cards 26. The package 24 should preferably be made with child safe materials and configured to hold the three-dimensional object 10, the removable attachment 12, the cards 26 and/or parent-child keepsakes. These parent-child keepsakes may include photos and any other meaningful items that may be used by the child to calm themselves during the absence of the parent. The parent may also use the package 24 to leave surprise messages and/or gifts to the child. The package 24 should be made of a sturdy material and of a thickness which makes them difficult to be destroyed (torn, ripped, chewed) if handled by a child. Preferably the package 24 is made of thick cardboard, but other materials are also envisioned, including, but not limited to plastic and wood. Preferably the package 24 is a box, but other configurations are envisioned, including, but not limited to tubes and bags.

As shown in FIG. 8, the adult would use the three-dimensional object 10 with child throughout the day, day-after-day, particularly as part of the child's routines and rituals with the parent. The continued use and close physical connection between the parent, three-dimensional object 10, and the child will allow the child to associate the three-dimensional object 10 with their parent and—where so configured—will result in the parent's scent transferring onto the soft three-dimensional object 10. For instance, the soft three-dimensional object 10 may be used by the parent in snuggling, feeding, while reading stories and/or playing games with the child.

Focusing on the example where the three-dimensional object 10 is a soft or semi-soft object, such as a lovie, one potential game using the lovie embodiment, would be a traditional game of “peek-a-boo.” As shown in FIGS. 1 and 2, where the soft, three-dimensional object 10 is a lovie, inclusion of a friendly animal character of the lovie would be designed for optimal appeal. However, even babies have preferences. So, the system may include alternative lovies and/or replacement animal character attachments for the existing blanket portion of the lovie to allow parents to modify the object to the child's preferences.

Where the three-dimensional object 10 is a rigid object, the described use rituals and routines would be the same, but the parent's scent would not be transferred.

As shown in FIG. 8, when the adult and child are together, the removable attachment 12 is preferably removably attached to the three-dimensional object 10.

The three-dimensional object 10 and removable attachment 12 may preferably be used to conduct “bye bye” and “hello” rituals between parent and child. These rituals would preferably involve calm quiet time focused on the relationship between parent and child and further include the physical disconnection/connection between three-dimensional object 10 and removable attachment 12. Upon disconnecting the removable attachment 12 from the three-dimensional object 10, the parent may tell the child that when they miss the child during their time apart they will touch the removable attachment 12 and think of them and that the child should do the same with the three-dimensional object 10. When the parent returns home, the parent greets the child and physically reconnects the removable attachment 12 to the three-dimensional object 10 and preferably spends one-on-one time with the child of at least a few minutes.

What is claimed is:

1. A system for promoting a secure parent/child attachment bond comprising:
a three-dimensional object;
an article that may be worn or otherwise easily carried by an adult; and
wherein the three-dimensional object includes means for temporarily attaching the removable attachment to the three-dimensional object.

2. The system of claim 1 wherein the three-dimensional object is capable of absorbing the scent of a human.

3. The system of claim 2 wherein the three-dimensional object is made of soft material.

4. The system of claim 3 wherein the three-dimensional object is a lovie.

5. The system of claim 4, wherein the lovie has an animal head.

6. The system of claim 1 further including a second removable attachment wherein the means for temporarily attaching the removable attachment may accommodate both articles.

7. The system of claim 1 further comprising cards carrying text that provides rituals, routines, and/or tips to promote parent-child bonding.

8. The system of claim 1 further comprising a box.

9. A system for promoting a secure parent/child attachment bond comprising:
a three-dimensional object;
an article that may be worn or otherwise easily carried by an adult, wherein the three-dimensional object includes means for temporarily attaching the removable attachment to the three-dimensional object;
a plurality of cards, wherein each card carries text that provides rituals, routines, and/or tips to promote parent-child bonding; and
a package.

10. The system of claim 9 wherein the three-dimensional object, removable attachment and cards are sized to fit in the package.

11. They system of claim 9 wherein the package is sized to hold the three-dimensional object, removable attachment, cards and at least one other object which is no larger than the three-dimensional object.

12. The system of claim 9 wherein the cards are bound together by a binding.

13. The system of claim 12 wherein the binding is a ring.

14. The system of claim 9 wherein the package is a box.

15. The system of claim 14 wherein the package is made of cardboard.

16. The system of claim 9 wherein the cards contain instructions to promote parent-child bonding.

17. A method for creating a secure parent/child attachment bond comprising:
providing a child with a three-dimensional object, wherein the three-dimensional object is attached to at least one article by an attachment means;
removing the at least one article attached to the three-dimensional object when at least one parent separates from the child;
providing the article to the parent when the parent separates from the child; and
re-attaching the article to the three-dimensional object by the attachment means at the time the parent returns to the child.

18. A method of claim 11 wherein the article is worn by the parent after it is removed from the three-dimensional object.

19. A method of claim 11 wherein two articles are removed from the three-dimensional object.

20. A method of claim 19 wherein the two articles are separately provided to two separate parents.
